(19) United States
(12) Patent Application Publication
(10) Pub. No.: US 2010/0134529 A1
(43) Pub. Date: Jun. 3, 2010

(54) SYSTEM AND METHOD FOR MATCHING COLORS ON DISPLAYS WITH DIFFERENT MODULATION TRANSFER FUNCTIONS

(76) Inventors: Ingo Tobias Doser, Donaueschingen (DE); Carlos Correa, Villingen-schwenningen (DE); Xueming Henry Gu, Calabasas, CA (US)

Correspondence Address: Robert D. Shedd, Patent Operations;THOMSON Licensing LLC, P.O. Box 5312, Princeton, NJ, 08543-5312, US

(21) Appl. No.: 12/452,361

(22) PCT Filed: Jun. 29, 2007
(86) PCT No.: PCT/US2007/015183

§ 371 Date: Dec. 28, 2009

(51) Int. Cl. G09G 5/10; G06K 9/00; H04N 5/445

(52) U.S. Cl. 345/690; 382/167; 348/564; 348/E05.099

(57) ABSTRACT

A system and method for adjusting modulation transfer function includes a color correction module configured to adjust source picture content based upon a reference display to output color corrected picture content. A modulation frequency function (MTF) simulation module is configured to receive the color corrected picture content and simulate the reference display using the color corrected picture content for a display with MTF characteristics different than the reference display.

### TECHNICAL FIELD

The present invention generally relates to color correction, and more particularly, to systems and methods for color correction of displays having different modulation transfer function behavior.

### BACKGROUND OF THE INVENTION

Many displays have a dependency between video bandwidth and picture-brightness. This relationship is represented by a Modulation Transfer Function (MTF). MTF can be described as a frequency sweep from zero frequency to a maximum spatial Nyquist frequency of a display varied in luminance. As the luminance is increased or decreased, a breakpoint moves towards lower or higher frequencies. In the case of a horizontal sweep, the spatial Nyquist frequency would be determined to be pixels per line/2. As the luminance is varied, the breakpoint, that is, the point where the discrete frequency can be pinpointed before it becomes flat, travels from left to right.

In a cathode ray tube (CRT), issues with MTF can be illustrated mainly as a problem of the electron beam hitting an anode. As the beam current increases, the dot size increases, causing a pixel overlap. This topic has been examined by Nic P. Lyons and Joyce B. Farrell in “Linear Systems Analysis of CRT Displays”, SID 89 Digest, pages 220-223, 1989.

In Plasma displays or DLP displays (digital displays), a grey level is achieved by flashing constant light over a certain period of time, and the time integral then determines the grey level. These grey levels are called “discrete levels”. A display that uses such time multiplexing has a maximum refresh speed and can only produce a limited number of grey levels. The remaining grey levels which are needed to reconstruct a video picture are usually produced by using dithering. Dithering is a way to trade contrast for spatial resolution. For example, if high spatial resolution is not required, luminance and/or color resolution can be improved by dithering at the cost of spatial resolution.

### SUMMARY OF THE INVENTION

Embodiments of the present invention include a system and method for color correction of displays having different modulation transfer function behavior. In one embodiment, a modulation frequency function (MTF) simulation module is configured to receive the color corrected picture content and simulate the reference display using the color corrected picture content for a display with MTF characteristics other than the reference display.

In one embodiment of the present invention, a method for adjusting a modulation transfer function includes color correcting a source picture content based upon a reference to output color corrected picture content, and simulating the reference by applying a compensated modulation transfer function (MTF) to the color corrected picture content for a display with MTF characteristics different than the reference.

In an alternate embodiment of the present invention, a system for adjusting a modulation transfer function includes a color correction module configured to adjust source picture content based upon a reference display to output color corrected picture content. A modulation frequency function (MTF) compensation module is configured to receive the color corrected picture content and transform the color corrected picture content for a display with MTF characteristics that are different than the reference display. The system can include an MTF simulation module coupled to the color correction module to store color correction metadata employed to transform the color corrected picture content by the MTF compensation module.

### BRIEF DESCRIPTION OF THE DRAWINGS

The teachings of the present invention can be readily understood by considering the following detailed description in conjunction with the accompanying drawings, in which:

FIG. 1 depicts a graph of an illustrative modulation transfer function with brightness on the y-axis and spatial resolution on the x-axis for a CRT display;

FIG. 2 depicts a graph of an illustrative modulation transfer function with brightness on the x-axis and spatial resolution on the y-axis for a CRT display;

FIG. 3 depicts a graph of an illustrative modulation transfer function with brightness on the x-axis and spatial resolution on the y-axis for a digital display;

FIG. 4 depicts a diagram illustrating a problem in conventional display content creation and consumption systems;

FIG. 5 depicts a block diagram illustrating MTF compensation for a display with different MTF behavior than a reference display in accordance with an embodiment of the present invention;

FIG. 6 depicts a block diagram illustrating MTF simulation to provide correction for a plurality of displays with different MTF behaviors in accordance with an embodiment of the present invention;

FIG. 7 depicts a diagram of a split screen for multiple reference images in accordance with an embodiment of the present invention;

FIG. 8 depicts a block diagram illustrating MTF simulation to provide two masters for displays with similar and different MTF behaviors in accordance with an an embodiment of the present invention;

FIG. 9 depicts a block diagram illustrating MTF simulation to provide correction for a plurality of displays with different MTF behaviors using metadata from the simulation process in accordance with an embodiment of the present invention;

FIG. 10 depicts a block diagram illustrating MTF simulation to provide correction information through metadata to an MTF compensation module for displays with MTF behavior different from a reference display in accordance with an embodiment of the present invention;

FIG. 11 depicts a block diagram illustrating MTF simulation based on a subsequent color correction process using an additional reference display to generate one master and to provide correction for a display with different MTF behavior, and a second master created by a previous color correction process for a display with the same MTF in accordance with an embodiment of the present invention;

FIG. 12 depicts a block diagram illustrating MTF simulation based on a subsequent color correction process using an additional reference display to generate one master and to provide correction for a display with different MTF behavior by computing a color transform based on simulation metadata and color correction metadata, and a second master created by a previous color correction process for a display with the same MTF in accordance with an embodiment of the present invention;

FIG. 13 depicts a high level block diagram of a module for computing a color transform in accordance with an embodiment of the present invention; and

FIG. 14 depicts a high level block diagram of a color transform module/circuit for computing an input signal for a display in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

Embodiments of the present invention advantageously provide methods and systems for color correction that implement a modulation transfer function (MTF) used in production of content in a reproduction display. Embodiments in accordance with the present principles provide that MTF characteristics used during the content production process are employed to predict/produce a desired spatial reproduction on reproduction displays. One reason that an exact reproduction of a given MTF behavior specification cannot be realized on the content production side is due to the existence of a large variety of such MTF behavior specifications. In fact, each particular model of a display manufacturer may have a different characteristic.

An exact reproduction is not required, as long as the content that is produced using the approximation will produce a better match to the original intent than pictures created without such model. To further improve the result, a reproduction display can calibrate to a “reference” model or display. There exist displays with many different MTF characteristics; in many cases, those MTF characteristics are designed into the display by means of signal processing. However, different display technologies exhibit their own characteristic MTF characteristic.

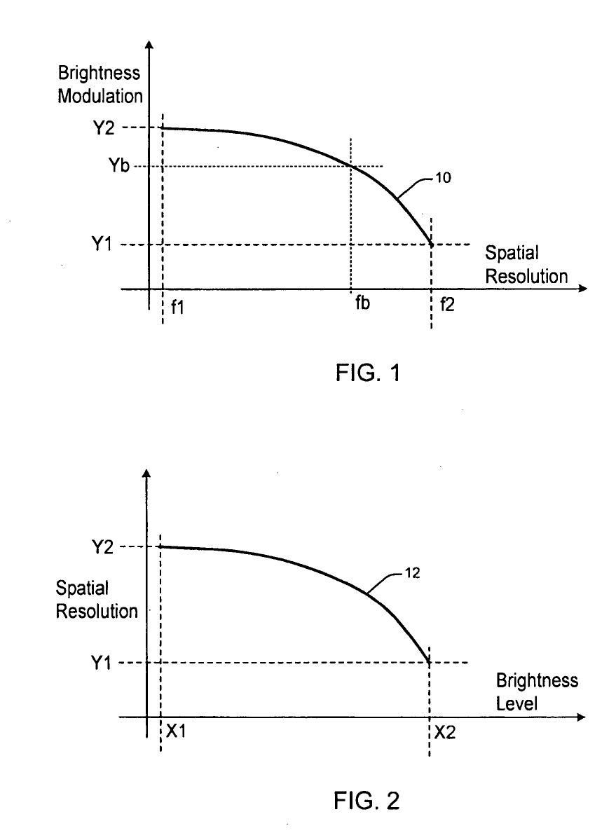

Referring now in specific detail to the drawings in which like reference numerals identify similar or identical elements throughout the several views, and initially to FIG. 1, a modulation transfer function 10 is shown over frequency (f), in cycles per picture element (pixel)—horizontally and/or vertically. In FIG. 1, the frequency range is between f1 and f2 for the spatial resolution. f1 and f2 correspond to brightness modulations Y1 and Y2, respectively. A breakpoint having the coordinates of (fb, Yb) is also depicted.

Referring to FIG. 2, a characteristic curve 12 of MTF behavior of a CRT is shown. The characteristic curve shows brightness level versus spatial resolution. The point spread and thus the characteristic MTF of a CRT changes with intensity or luminance. FIG. 2 shows an increasing spatial point spread with increasing intensity or luminance.

Thus, the characteristic MTF behavior of a CRT can be described as a lowpass filter with a decreasing cut-off frequency with increasing luminance. There is an independent function for each of the colors. However, there may be crosstalk from other effects like power limitations leading to different electron beam speeds resulting in different point spreads.

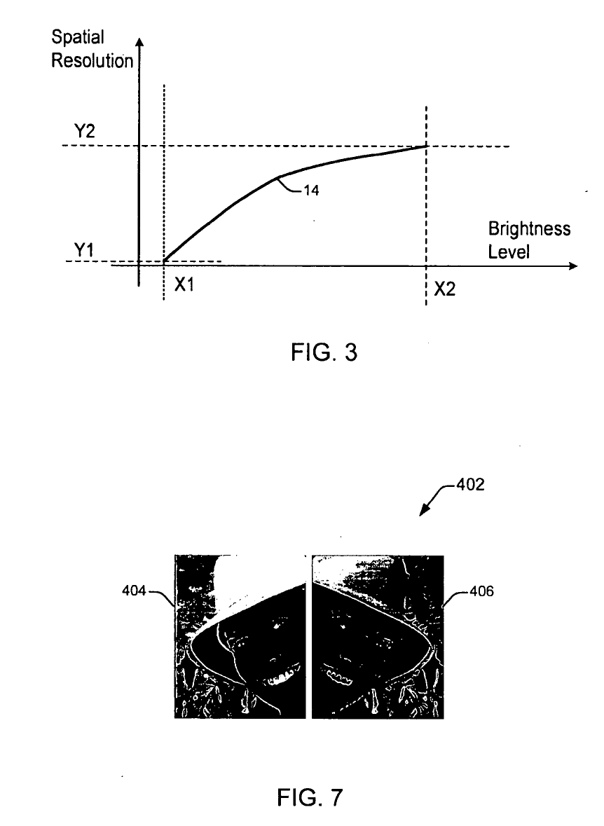

Referring to FIG. 3, a characteristic curve 14 for a pulse-width modulated (PWM) display, such as a Plasma or DLP display, is illustratively shown. The curve 14 shows spatial resolution versus brightness level. PWM displays rely on dithering to meet bit depth requirements. In case of error diffusion, dithering distributes the error among neighboring pixels. Large errors need more pixels for compensation as compared with small errors, which can employ fewer pixels. Since these displays are fundamentally linear displays (light time is equal to the grey level), the available discrete levels are mainly distributed evenly in the linear space. Some more advanced coding schemes make advantage of the non-linear light sensitivity of the human visual system. However, the lower end of the brightness scale is still significantly more prone to color errors than the upper end of the brightness scale. Large errors need many pixels to equalize the error; therefore the achievable spatial frequency is reduced accordingly.

Displays using plasma technology generally exhibit a behavior of reduced spatial resolution with decreasing local brightness (see FIG. 3). CRT's, however, exhibit the opposite behavior (see FIG. 2). Displays based on liquid crystal display (LCD) technology, exhibit a constant spatial resolution over the brightness scale, but not when the temporal domain is taken into account (as opposed to the frequency domain).

In the present disclosure, comparisons are made between a picture version for displays with an MTF behavior different from the MTF behavior of a reference display, and a picture version for displays with an MTF behavior equal to the MTF behavior of the reference display, or metadata for reconstructing the picture for displays with an MTF behavior different to the MTF behavior of the reference display. It should be noted that there are several MTF specifications that should be regarded, e.g., at least one specification for the CRT behavior, and at least one specification for Plasma or DLP type of behavior.

When editing the colors of a picture on a display other than a target display, a potential problem arises where spatial appearance on the target display may be different than expected. The present embodiments advantageously edit colors (color correct, color grade) in anticipation of the behavior of the target displays and provide practical ways of implementing methods for performing the same.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

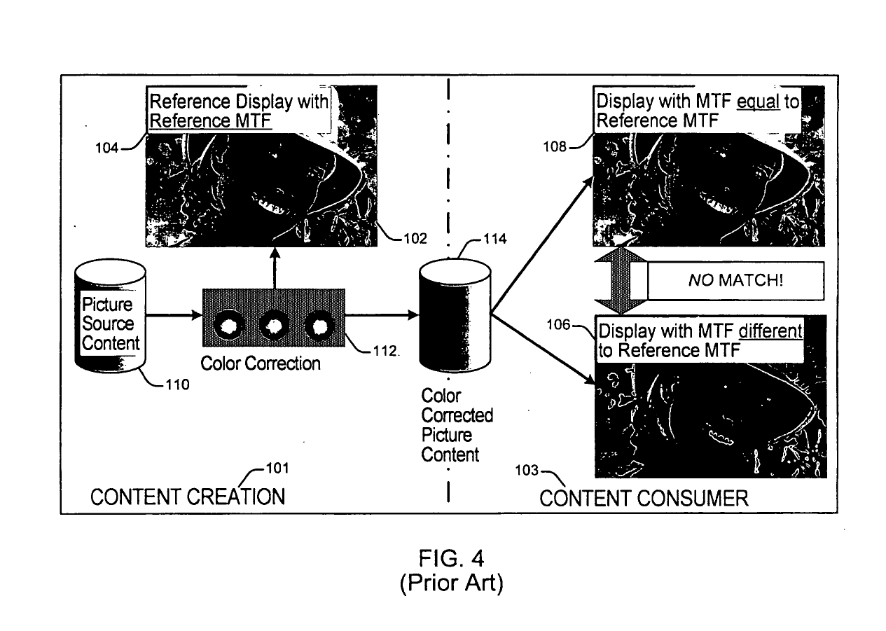

Referring to FIG. 4, a diagram shows color correction using a display 102 with a reference modulation transfer function (MTF) 104 in accordance with a conventional set up. Picture source content 110 is input to a color correction process 112. In conjunction with the color correction process 112, the reference display 102 is employed along with the reference MTF to provide color adjustments to images of the content. Color corrected picture content 114 is then provided to content consumers of a consumer content side 103.

A content creation side 101 includes the facilities needed to provide color correction or other adjustments to video content. A content consumer side 103 includes equipment to view the video content.

When color correcting on display 102 with the reference MTF behavior, the spatial reproduction will be incorrect on a display 106 with an MTF behavior different from the MTF behavior of the reference display 102. Two displays 106 and 108 are illustratively compared; both have the same number of pixels. Display 106 includes MTF behavior different from the MTF behavior of the reference display 102, and display 108 includes MTF behavior equal to the MTF behavior of the reference display 102. In CRTs, pictures with higher brightness will look significantly sharper on the display 108 with an MTF behavior different from the MTF behavior of the reference display 102. For a plasma display, the display 108 with MTF behavior different from the MTF of the reference display 102 will be less sharp than for the display 106.

Dark pictures, on the other hand, can look smoother on the plasma display than they look on the CRT display. As a result, details in the picture that are felt to be important can get lost or, artifacts that the content creators were not aware of, like noise or film grain, will be over accentuated on the plasma display, for example.

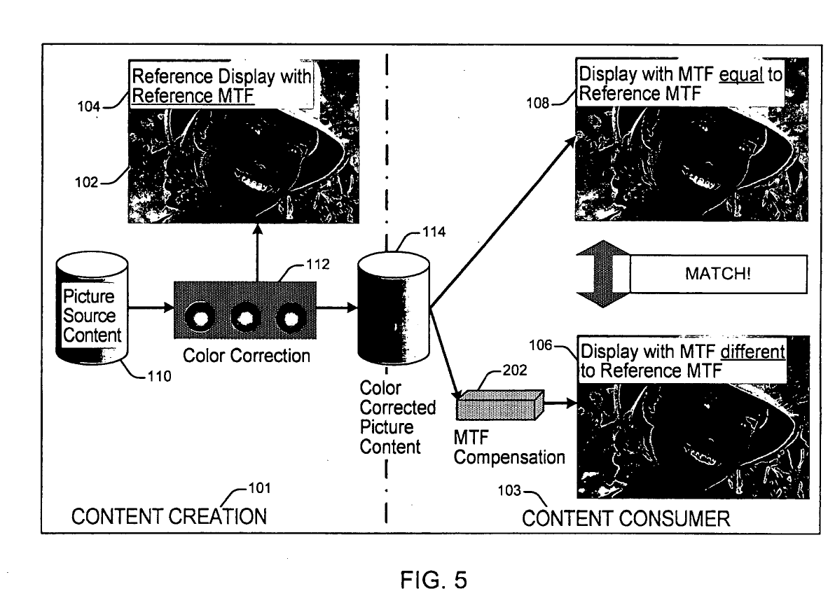

Referring to FIG. 5, a diagram shows color correction using a display 102 with a reference modulation transfer function (MTF) 104. In accordance with one embodiment, a MTF compensation module 202 is employed prior to displaying a picture on a display with an MTF behavior different from the MTF behavior of the reference display 102. One way of retrieving the original look of the picture includes compensating for the difference in MTF behavior of the displays by applying an inverse characteristic and then routing the resultant signal to the display 106 with MTF behavior different from the MTF behavior of the reference display 102. While some colors and details in the picture can be retrieved with this solution, other details, especially the darker details, are more difficult to display, if the above mentioned constellation of CRT for reference MTF behavior and Plasma for non-reference MTF behavior is taken. The outcome would again be a picture that is different from the picture seen during content creation. Furthermore, potential advantages of the Plasma technology could not be utilized.

The MTF compensation module 202 may include the ability to determine the type of reference display 102 where the color corrected picture content 114 was produced. Then, the inverse characteristic is referenced for the display type of display 106. Next, the inverse characteristic is applied to the MTF for the referenced display 102 to provide a better match between the reference display 102 and the content consumer display 106.

It should be understood that the FIGS. include a content creation side 101 and a content consumer side 103. However, the elements depicted on the content consumer side 103 may be implemented and the content creation side 101 and vice versa. In addition, content creation 101 may include production facilities for rendering video for cable or other networks, television, movie studios, DVD's, VHS tapes or any other content production. The content consumer 103 may include movie theatres, televisions, or any other content consumer. The MTFs may be embodied in a look up table, analytical transfer function, data graph or any other relationship between spatial resolution and brightness. The color correction process provides changes to this curve which may be employed in MTF compensation 202. Alternately, MTF compensation may be performed by comparing MTFs between the consumer display (106) and the reference display and counteracting the differences to achieve the same or similar result as the reference display 102.

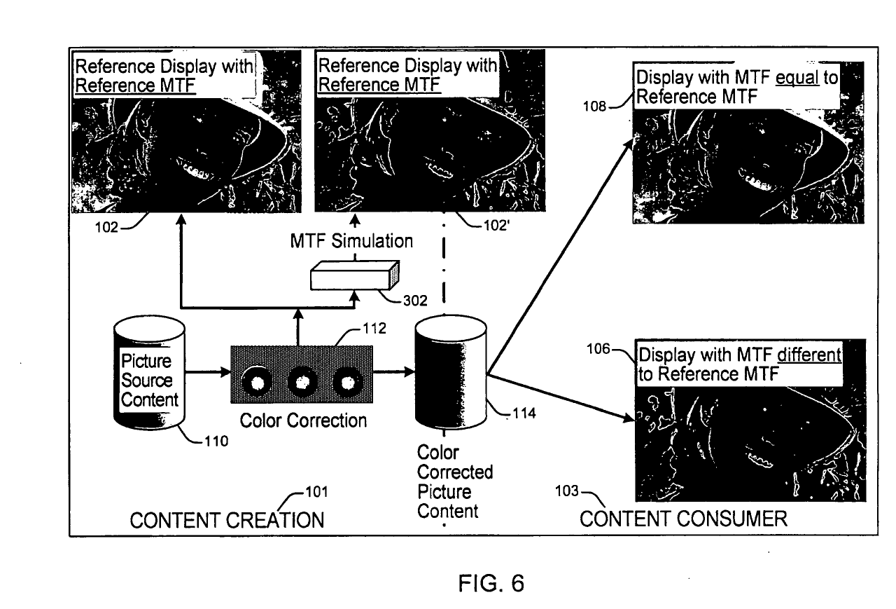

Referring to FIG. 6, a system for predicting variations in spatial and color appearance between displays with MTF behavior different from the MTF behavior of the reference display during the content creation process is illustratively depicted. In this way, the composition on such a display is known during content production and counter measures can be taken on the content creation side 101 of the process.

Differences in look on displays (106) with MTF behavior different from the MTF behavior of the reference display 102, and displays 108 with MTF behavior equal to the MTF behavior of the reference display, or other displays with different types of MTF behavior can be addressed during content creation 101. In accordance with one embodiment, MTF differences can be predicted, and color decisions and spatial enhancement decisions can be made to make sure that the artistic intent is not compromised by one of the displays taken into consideration. In this embodiment, during content creation, a reference display 102 with an MTF is compared to a different reference display 102′ with the same MTF. An MTF simulation module 302 includes the capability to adjust the MTF to arrive at a satisfactory picture appearance. The adjustments made in the MTF simulation module 302 may be employed to create an inverse characteristic curve or a new MTF to be employed with consumer displays (e.g., display 106 in FIG. 6) of the same type as reference display 102′. In this simulation, to start the simulation and correction, displays 102 and 102′ may be the same display type with different MTF's, different display types with the same MTF's or different display types with different MTF's.

The simulation employed by simulation module 302 helps to achieve the best compromise for all displays. This may mean that not all wanted color compositions are possible although some displays would have the potential to support them. The resultant picture material (content 114) would be color corrected to meet the least common denominator among all displays expected for viewing. In accordance with this implementation, a single corrected picture content 114 may be sent to all display types with the settings designed to provide a negotiated appearance that is satisfactory for all display types.

Display 106 with an MTF behavior different from the MTF behavior of the reference display 102′ used during content creation could be a reference display of that type with a well characterized and documented specification, or display 102′ could be a reference display of another type, for example, with an MTF behavior equal to the MTF behavior of the reference display 102, with MTF simulation circuitry 302. Advantageously, using the simulation circuitry 302 in this way offers the opportunity of having different display characteristics on one display without the need of an arrangement of several displays in a color correction suite.

As shown in FIG. 7, a split screen display 402 may be provided for comparing the two display characteristics on a single display. Display 402 may include a partial screen 404 which employs a first MTF and a second partial screen 406 that employs a different MTF. The split screen display 402 provides a very practical solution since a side-by-side comparison between different MTF can be performed. A screen 402 may be segmented into any number of partial screens.

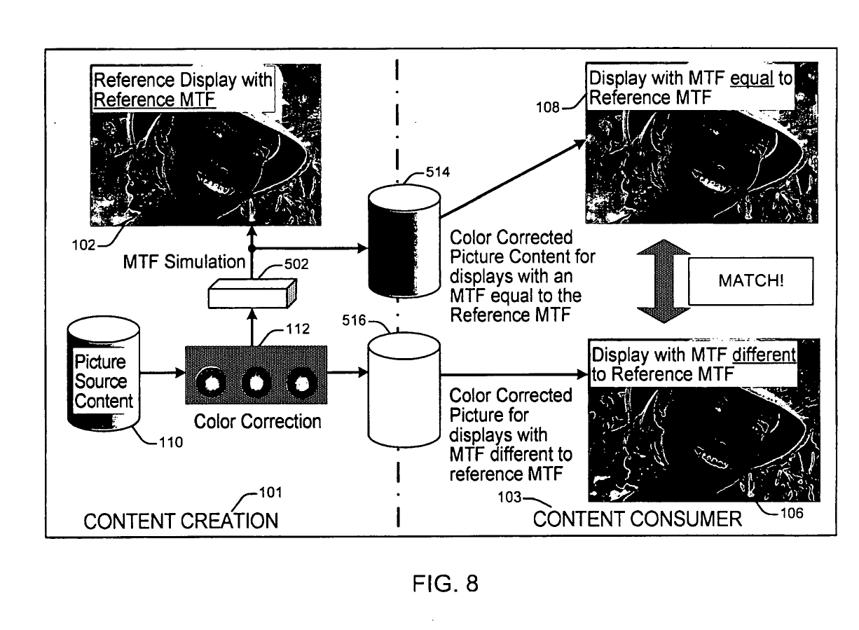

Referring to FIG. 8, in another embodiment multiple color corrected masters (e.g., 514 and 516) are employed. In this embodiment, an MTF behavior specification is employed while color correcting. This results in two masters 514 and 516. One master 516 is used for displays 106 with an MTF behavior different from the MTF behavior of the reference display 102, and one master 514 is used for displays 108 with an MTF behavior equal to the MTF behavior of the reference display 102. The color correction is preferably performed on the master 516 with the MTF behavior different from the MTF behavior of the reference display 102, and the master 514 with an MTF behavior equal to the MTF behavior of the reference display may be a derivative of master 516. The derivative master 514 is created using an MTF simulator 502 (which functions the same as simulator 302) to enhance the MTF for the reference display 102. In this way, improved results are achieved, and the colors can be matched better between a consumer display 106 with an MTF behavior different from the MTF behavior of the reference display 102 and a display 108 with an MTF behavior equal to the MTF behavior of the reference display 102. This is provided that the MTF behavior specifications match with those specifications in the field, or the display in the field is calibrated to the specification used during color correction.

In this example, there is a singular specification for the display 102 with the reference display MTF behavior, and yet multiple MTF behavior specifications will have to be considered for versions of displays with different (e.g., display 106) MTF behaviors from the MTF behavior of the reference display 102. It would be advantageous if the initial version of the MTF master was the version for a display 102 with reference MTF behavior.

To find a compromise, a colorist may, for example, blur or noise reduce an image that shows too much grain or noise. The colorist may also change the color of one particular object to change it to a brightness level where the details can be better reproduced on one of the displays.

In contrast to the embodiment described with reference to FIG. 8, other embodiments herein will have no details or colors in the master that cannot be displayed by a display with an MTF behavior different from the MTF behavior of the reference display 102. This is becomes a significant advantage.

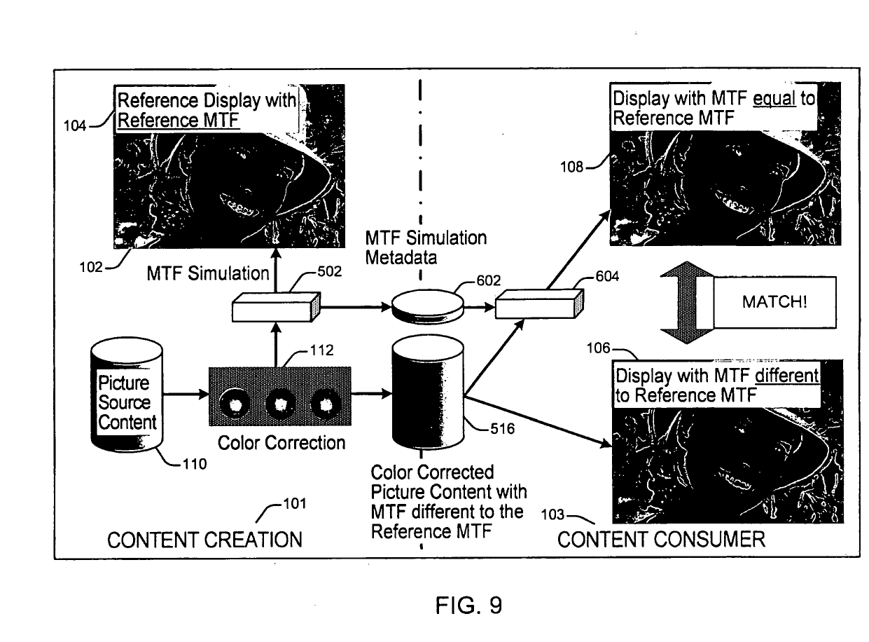

Referring to FIG. 9, another embodiment is depicted where display 106 has MTF behavior different from the MTF behavior of the reference display 102. Display 108 uses an MTF simulation created during color correction by MTF simulation 502. The result is one master for displays (e.g., 106) with MTF behavior different from the MTF behavior of the reference display 102. The MTF simulation module 502 collects metadata 602 describing the transformation of the picture with an MTF behavior different than the MTF behavior of the reference display 102 into a picture with an MTF behavior equal to the MTF behavior of the reference display 102. The metadata 602 is employed in a second MTF simulation module 604 which converts or adjusts the content 516 for display 108.

The term “metadata” refers to data such as, for example, integer, non-integer values, and/or Boolean values, used to control, turn on or turn off color processing mechanisms, and to modify the functionality of such. Furthermore, metadata may include a specification of a mapping table.

One difference between the embodiment of FIG. 8 and the embodiment of FIG. 9 is that there will be a single inventory master 516, with metadata 602 describing the difference between the details and colors for a display 106 with an MTF behavior different to the MTF behavior of the reference display 102 and a display with an MTF behavior 108 equal to the MTF behavior of the reference display 102. The color transform described by the metadata 602 is similar to a color transform defined by the reference MTF specification 104. The metadata may include, for example, breakpoints, color thresholds, functions selections, weighting factors or other information that can be employed to describe differences between MTFs. The metadata may also include adjustment settings or other information provided during the color correction process.

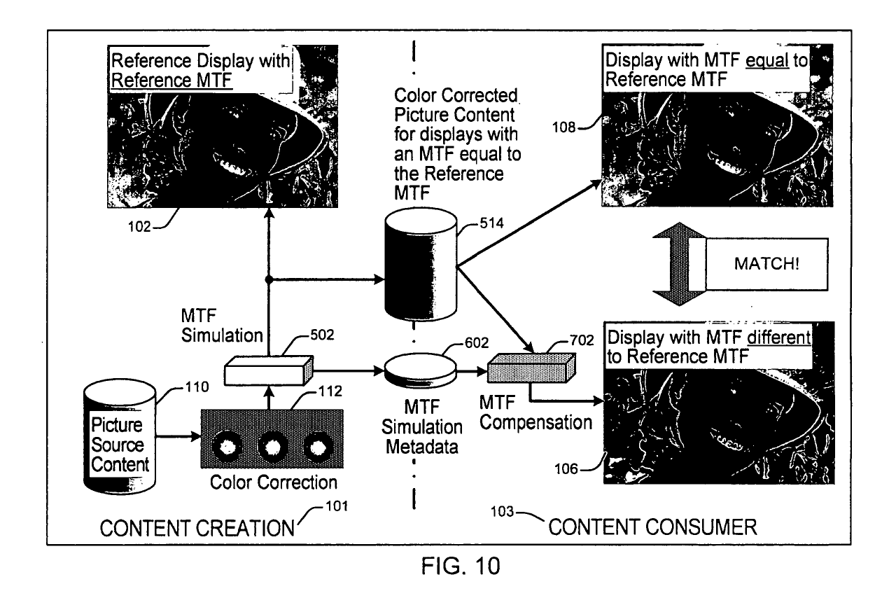

Referring to FIG. 10, in this embodiment, display 106 with an MTF behavior different from the MTF behavior of the reference display 102 employs an MTF simulation 502 during color correction. The MTF simulation 502 results in one master for displays 108 with an MTF behavior equal to the MTF behavior of the reference display 102. In addition, metadata 602 describing a transformation of the picture with an MTF behavior equal to the MTF behavior of the reference display 102 into a picture with an MTF behavior different from the MTF behavior of the reference display 102 is provided. The metadata 602 may be, for example, a description of an inverse transform of the MTF simulation transform (from MTF simulation 502) used for color correction. The metadata 602 would be employed by an MTF compensation module 702 that uses the inverse transform of the MTF and applies the inverse transform to the picture content 514 with the reference MTF from the reference display 102. One difference between the embodiment shown in FIG. 10 and the embodiment shown in FIG. 9 is that the single inventory master 514 is based on the version with an MTF behavior equal to the MTF behavior of the reference display 102.

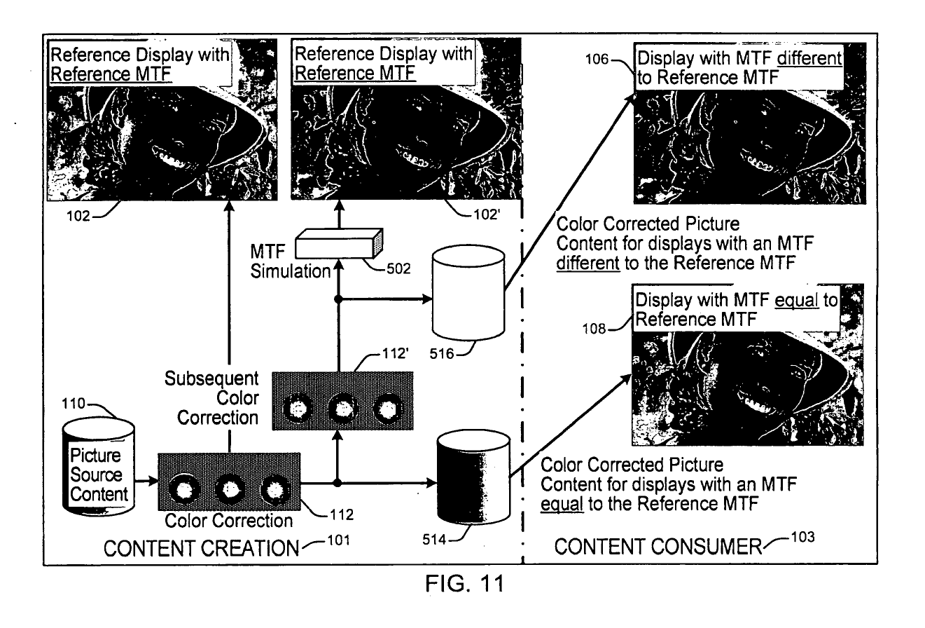

Referring to FIG. 11, in this embodiment, picture source content 110 is color corrected by color correction process 112 using reference display 102. The color corrected picture content is forwarded to create a first master 514 for displays with an MTF behavior equal to the MTF behavior of the reference display 102. A subsequent color correction is provided using reference display 102′ by a color correction process 112′ for creating a secondary master 516 for displays 106 with an MTF behavior different from the MTF behavior of the reference display 102′.

A two step color correction is advantageously performed. In a first step, color correction 112 is applied where the colors are corrected for the reference display 102 with reference MTF behavior. Then, the picture is put onto the display 102′ with an MTF behavior different from the MTF behavior of the reference display 102 (or its corresponding simulation 502), accepting the spatial resolutions to fall where they may fall. In a secondary color correction process 112′, the colorist is given the ability to adjust the colors and spatial parameters in a way to preserve artistic intent on the display 106 with an MTF behavior different to the MTF behavior of the reference display 102′. However, in this scenario it is accepted that the two versions of the picture for display 106 and display 108 may not completely match. The two versions are then stored as separate masters 516 and 514.

Display properties of the different displays may not be fully exploited, namely the picture may not be as sharp in dark regions as it could get on a display with an MTF behavior equal to the MTF behavior of the reference display, and the picture may not be as sharp in bright regions as it could get with an MTF behavior different than the MTF behavior of the reference display. This problem is solved by providing the second color correction process 112′, which permits particular features of a given display to be exploited using additional color correction adjustments.

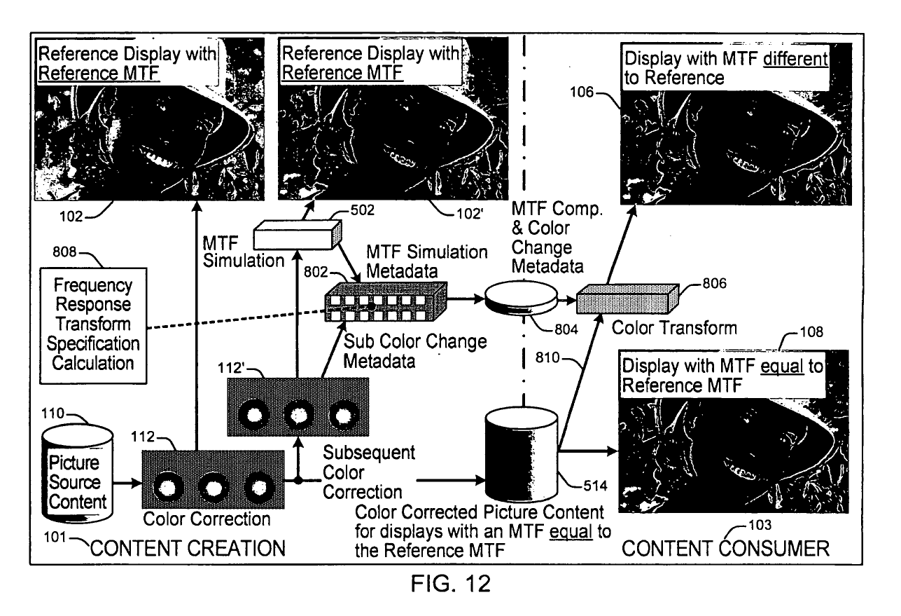

Referring to FIG. 12, in this embodiment, one master 514 is created for displays 108 with an MTF behavior equal to the MTF behavior of the reference display 102. This master 514 is created by employing a color correction process 112. A subsequent color correction process 112′ is performed on the output of the first color correction process 112 for creating a second version for displays 106 with an MTF behavior different from MTF behavior of the reference display 102′. Instead of creating two masters, a color transform 806 is calculated using the subsequent color correction process 112′ transform information. The transform information may be generated from MTF simulation 502 or from the color correction process 112′ of reference display 102′, which is the same or similar to display 106.

A frequency response transform specification calculation 808 is performed to generate MTF compensation and color change metadata 804. The combined metadata 804 would then be provided to a consumer device in the form of the color transform 806 which is then able to reconstruct the version for displays with an MTF behavior different to the MTF behavior of the reference display 102′ using a signal transform that uses the transform specification 806.

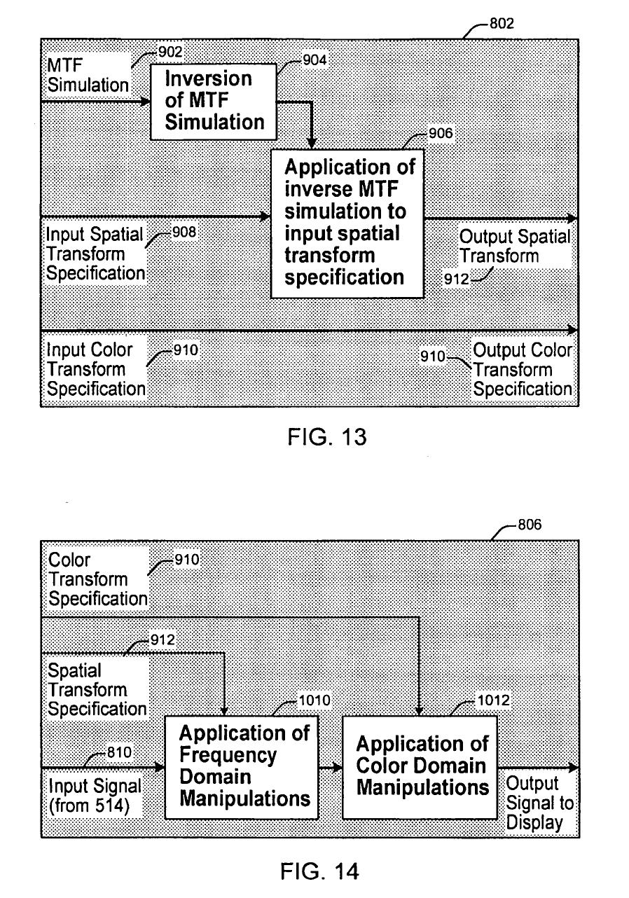

In some applications, it may not be preferable to have separate or multiple masters for different MTF characteristics. In such cases, it is preferable to have a single source of content and metadata describing a color transform 806 that is necessary to retrieve the MTF characteristic version needed. On the consumer side, transform 806 may be provided that connects a signal source with a display (106) with an MTF behavior different than the MTF behavior of the reference display 102. Transform 806 can be implemented in hardware (circuitry) or in software, and can provide the signal transform to generate the version of MTF specification needed out of the signal for displays with an MTF characteristic equal to the reference display 102. This transform 806 may be provided with the signal transform specification from the content provider by means of metadata 804. The signal transform specification (806) may include two major components, a specification of the color change from the subsequent color correction 112′, which is basically a spatial domain operation, and a specification of an MTF compensation plus spatial picture manipulations from simulation 502, which are frequency domain operations (see FIG. 13).

Referring to FIG. 13, in one exemplary application, MTF simulation metadata 802 is illustratively shown for transforming, color and MTF simulation information into a color transform 806. MTF specification correction may be implemented using a look-up table (LUT) of fast Fourier transform (FFT) coefficients for different intensity levels. These coefficients are employed to attenuate selected frequency bands. Information 902 from MTF simulation (502) is input to a module 904 where the MTF simulation curve is inverted. Here, the MTF correction inversion means that each coefficient will be equal to 1 over the input coefficient, although other inversions are contemplated. The result would then be point-wise multiplication of the coefficients of the frequency response change during color correction in block 906.

Spatial modifications performed by color correction (112′) are specified to block 906 by, e.g., a LUT of FFT coefficients for different intensity levels. These coefficients are used to attenuate frequency bands. The inversion of the MTF simulation 904 and a spatial transform specification 908 are input to block 906, where the application of the inverse MTF simulation to an input spatial transform specification is performed. The color modifications from input color transform specification 910 made by color correction 112′ are specified by a 1-D LUT (e.g., one per color component). An output color transform 910 and spatial transform 912 result from the operations performed.

Referring to FIG. 14, circuitry 806 on the consumer side includes a frequency response manipulation unit 1010 and a color manipulation unit 1012. Unit 1010 will be fed with the frequency domain transform specification 912, and unit 1012 is fed with the color domain transform specification 910. The manipulations performed by units 1010 and 1012 use the respective transformation information and apply the transformation information to an input signal 810. Input signal 810 is delivered from content 514, which includes color corrected content for a reference display 102. The transformations use the information obtained by a second color correction process 112′ using a second reference display 102′ to permit artistic intent to be duplicated as described above and output to a display.

Having described preferred embodiments for a color correction system and method for matching colors on displays with different modulation transfer function behavior (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. While the forgoing is directed to various embodiments of the present invention, other and further embodiments of the invention may be devised without departing from the basic scope thereof.

1. A method for adjusting a modulation transfer function comprising:
color correcting a source picture content based upon a reference display; and
simulating the reference display by applying a compensated modulation transfer function (MTF) to the color corrected picture content for a display with different MTF characteristics than the reference display.

2. The method of claim 1, further comprising determining MTF settings for a plurality of display types using a single master for the color corrected picture content.

3. The method of claim 1, wherein applying the compensated MTF includes applying an inverse function of an MTF specification for simulating the reference display.

4. The method of claim 1, wherein simulating includes using multiple reference display and comparing images of the multiple reference displays to derive an MTF specification for simulating a display with different MTF behavior.

5. The method of claim 1, wherein the multiple reference displays include a split screen image.

6. The method of claim 1, further comprising generating multiple master copies for the color corrected picture content.

7. The method of claim 6, wherein the multiple master copies for the color corrected picture content include one master generated by the color correcting step and one master generated by the simulating step.

8. The method of claim 1, wherein simulating includes generating metadata based upon color correction settings, the metadata being transmitted to an MTF simulator for content consumers such that the MTF simulator reconstructs MTF characteristics for a given display device.

9. The method of claim 1, further comprising performing a subsequent color correction process where the subsequent color correction process is preceded by a previous color correction process, the previous color correction process providing color corrected picture content for a display with MTF characteristics similar to an additional reference display, and the subsequent color correction process employing the MTF simulation module to provide color corrected picture content for a display with MTF characteristics different than the reference display.

10. The method of claim 9, further comprising color transforming simulation metadata from the step of simulating and color change metadata from the subsequent color correction to manipulate content for a display with different MTF characteristics than the reference display.

11. The method of claim 10, further comprising manipulating an output from the previous color correction process to provide a signal for display.

12. A system for adjusting a modulation transfer function comprising:
a color correction unit configured to adjust source picture content based upon a reference display to output color corrected picture content; and
a compensation unit configured to receive the color corrected picture content and transform the color corrected picture content for a display with modulation transfer function (MTF) characteristics that are different than the reference display.

13. The system of claim 12, further comprising simulation unit coupled to the color correction unit to store color correction metadata used to transform the color corrected picture content by the compensation unit.

14. A system for adjusting a modulation transfer function comprising:
a color correction unit configured to adjust source picture content based upon a reference display to output color corrected picture content; and
a simulation unit configured to receive the color corrected picture content and simulate the reference display using the color corrected picture content for a display with modulation frequency function (MTF) characteristics different than the reference display.

15. The system of claim 14, wherein the simulation unit outputs color corrected picture content to a display with MTF characteristics that are the same as the reference display.

16. The system of claim 14, wherein the simulation unit outputs color corrected picture content to a display with MTF characteristics that are different than the reference display.

17. The system of claim 14, further comprising an additional reference display wherein the reference display and the additional reference display are used to determine MTF settings that are acceptable for both the reference display and the additional reference display.

18. The system of claim 17, wherein the reference display and the additional reference display comprise a single display device having a split screen image.

19. The system of claim 14, wherein the simulation module provides metadata based upon color correction settings, the metadata being transmitted to a simulator for content consumers such that the simulator reconstructs MTF characteristics for a given display device.

20. The system of claim 14, wherein the color correction process unit performs an initial color correction process and a subsequent color correction is subsequently provided, the initial color correction process providing color corrected picture content for a display with MTF characteristics the same as an additional reference display, and the subsequent color correction process employing the simulation unit to provide color corrected picture content for a display with MTF characteristics different than the reference display.

21. The system of claim 20, further comprising a color transform module configured to receive simulation metadata from the simulator unit and color change metadata from the subsequent color correction to manipulate content for a display with different MTF characteristics than the reference display.

22. The system as recited in claim 21, wherein the color transform unit manipulates an output from the previous color correction process to provide a signal for display.

23. The system of claim 21, wherein the color transform unit receives as input a spatial transform specification, and a color transform specification and outputs a color transform to adjust a display image.

24. The system of claim 23, wherein the spatial transform specification includes inverted MTF simulation information, and the spatial transform specification, and the color transform specification include transform coefficients for adjusting frequency bands.

25. The system of claim 24, wherein the coefficients are stored in look up tables.
